(19) United States
(12) Patent Application Publication
(10) Pub. No.: US 2023/0281350 A1
(43) Pub. Date: Sep. 7, 2023

(54) A Computer Implemented Method of Generating a Parametric Structural Design Model

(71) Applicant: BIM & Scan Limited, Balbriggan, County Dublin (IE)

(72) Inventor: Shawn O'Keeffe, Balbriggan, County Dublin (IE)

(21) Appl. No.: 18/000,026

(22) PCT Filed: May 26, 2021
(86) PCT No.: PCT/EP2021/064093

§ 371 Date: Nov. 28, 2022

(30) Foreign Application Priority Data
May 26, 2020 (GB) 2007809.3

(51) Int. Cl. G06F 30/13

(52) U.S. Cl. CPC G06F 30/13; G06F 2119/02

(57) ABSTRACT

This invention relates to a computer implemented method of generating a parametric structural design model from a built structure, a computer program product and an apparatus for performing the method. The computer implemented method comprises the steps of receiving a point cloud (PC) representation of the built structure and thereafter generating a plurality of planes from the PC. Planes that are representative of objects to be included in the model are stored in memory. Other planes that are not representative of objects to be included are discarded. The properties of the objects included in the parametric structural design model are retrieved from an Industry Foundation Classes (IFC) standard and the parametric structural design model is generated with the chosen planes and the properties of those objects from the IFC standard In this way, the generation of the model is more efficient and less computationally burdensome than was heretofore the case.

### TECHNICAL FIELD

This invention relates to an unsupervised computer implemented method for generating a parametric structural design model. More specifically, the invention relates to a computer implemented method for generating a parametric structural design model from a built structure, and a computer program product having program instructions for implementing the method.

### BACKGROUND ART

When undertaking any 3D reconstruction project, it is common practice to create three dimensional (3D) representations of desired objects from existing data, for example, point clouds, photogrammetry, construction drawings, and the like. For example, it is not uncommon to create models from point clouds prior to creating a retrofit design where the model reconstructed from the point cloud is needed as a basis for the new design.

However, there is a problem with this approach. If other stakeholders would like to use this new model, then they would have to use the same software as utilized in the manual generation of said model. It is common practice for the desired model to not be locked into one design package, therefore, a common platform neutral approach is utilized. A platform neutral approach is realized when the method entails using an Industry Foundation Classes (IFC) data model. Heretofore, the techniques used for 3D reconstruction of design structures from built structures are largely manual, tedious, and time consuming in nature. A great deal of the manual modelling is largely subjective and therefore open to interpretation and dispute.

One increasingly popular technique known in the art is to generate a design model of the built structure from the point cloud with off-the-shelf 3D modelling software. By doing so, in some cases it is possible to model parametric design models from point clouds and the resulting model can be used as a basis for the design model to build further upon.

However, this methodology becomes very problematic particularly when it is desired to share the model and coordinate the model with other disciplines. For example, it is common for the 3D reconstructed model to be Architectural and Structural in nature, and then it may be necessary to coordinate with other new designs such as Mechanical, Electrical, and Plumbing (MEP) systems. Furthermore, Building Controls, Fire, and Security systems may also be added to the model. All of the previously mentioned models will need to be added to and coordinated with a Civil design model structure which is not trivial, and difficulties arise. The best practice would be for all of the above disciplines to use ISO 16739 formatted models and coordination models using ISO 10303-21 would be preferred. However, co-ordination of the different disciplines is difficult to achieve in practice. Furthermore, even with the use of point clouds, the techniques require the operator to open up several software packages, perform substantial post processing of the data, and thereafter opening that data (PC) in a design application and subjectively tracing the PC with model objects to attempt to make a correct model from the PC.

In addition, there are further problems with modelling a parametric structural design model from a built structure using a point cloud. Typically, the model generating from the point cloud will vary each time a new point cloud is taken. This can lead to disagreements between parties relying on the model and distrust in the veracity of the model. Secondly, the point clouds are extremely computationally expensive to produce and can take up substantial amounts of processing power and time which is undesirable. Thirdly, once created, modification of the component parts of the model is time consuming to perform. It is necessary to define the parameters that apply to each object and the attributes of that object, which is a very time consuming, labour intensive process.

One methodology known in the art is that described in Remote Sensing, Vol 7, 2015, in an article by Charles Thomson et al. entitled “Automatic Geometry Generation from Point Clouds for BIM”, pages 11753-11775. This paper discusses a technique in which the major horizontal planes are detected, the vertical planes are detected and an IFC geometry is thereafter built from point cloud segments. After the model is built, it can be “cleaned up” to weed out false positives.

Although useful, there are a number of problems with the approach described in Thomson et al. First of all, the method described attempts to clean up the model after it has been generated. This is disadvantageous for a number of reasons including that it may be considered to be computationally heavy and computationally inefficient. Secondly, the model is generated from clusters of assumed points, assumed to represent posing points for the generated model. This can lead to a lack of precision in the generated model. Thirdly, the method described in Thomson et al does not appear to be able to generate other structural objects in their model and it would be advantageous to have the ability to do so. Finally, although useful, the method described in Thomson et al is understood to be unable to handle occlusions (i.e. clutter) in an entirely satisfactory manner, resulting in difficulty creating walls and other structures.

It is an object of the present invention to provide a computer implemented method and a computer program product that overcome at least some of the above-identified problems with the known offerings. It is a further object of the present invention to provide a computer implemented method and computer program product that offer a useful alternative choice to the consumer.

### SUMMARY OF INVENTION

According to the invention there is provided a computer implemented method of generating a parametric structural design model from a built structure comprising the steps of:
receiving a point cloud (PC) representation of the built structure;
generating a plurality of planes from the PC;
determining those planes that are representative of objects to be included in the parametric structural design model and storing those planes in memory;
determining those planes that are not representative of objects to be included in the parametric structural design model and discarding those planes;
retrieving the properties of those objects to be included in the parametric structural design model from an Industry Foundation Classes (IFC) specification containing object property specifications; and
generating the parametric structural design model with the planes representative of the objects to be included, and the properties of those objects from the IFC specification.

By having such a computer implemented method, it will be possible to create the parametric structural design model using a fraction of the computational power previously required. By generating the plurality of planes and then only keeping those planes necessary for the generation of the model, the model can be created faster in a more streamlined fashion. Unnecessary processing is avoided. The planes may be manipulated with ease to generate the model and stored in a more compact manner. Furthermore, the use of planes will allow for superfluous information to be disregarded quickly. In addition, the approach used automatically creates platform neutral IFC formatted models from point clouds, thereby facilitating use across multiple parties and multiple disciplines.

The main advantages of generating the plurality of planes is the removal of occlusions and false positive planes in areas where there are empty spaces or insufficient points within the PC. The planes allow for the problems in the case of occlusions to be overcome. Traditionally modelling from point clouds with occlusions is very problematic, due to the fact that occlusions are missing data where some object has occluded that data from being captured. In the case of the plane creation, this helps where there is missing data required for the modelling of walls. For example, the plane simply goes across to cover the occlusion/hole in the data. In addition, the removal of false positive planes is a resulting byproduct of the method whereby correct, or needed planes for future steps such as wall candidate selection are the only planes left, and any false positives, i.e. mistaken plane placements, are removed.

Importantly, by retrieving the properties of those objects to be included in the parametric structural design model from an Industry Foundation Classes (IFC) specification containing object property specifications, it is possible to also store attributes of those objects and those attributes will not only help in the quick generation of the model, but will also allow modification of the attributes for model modification and quick adjustment. In addition to the foregoing, in this way, the invention creates IFC coordination models directly from the point cloud, and said models are formatted using ISO 10303 Part 21, i.e. STEP Physical File Format (SPFF).

In one embodiment of the invention there is provided a computer implemented method in which the PC contains a data set with a plurality of data points, one or more scan positions, and in which each of the data points has a 3D coordinate value (XYZ), and a scan index value associated therewith. The scan index value is based on the order of PCs input to the algorithm, i.e. scan index 0 is the first, 1 the second, and so on in ascending order, if multiple scans are provided as input. This is seen as a useful embodiment of multiple potential room locations that will help to provide a more accurate model, taken over a number of PCs. Furthermore, the scan index value will provide a useful identifier for location of a data point in the structure as well as the properties of the object associated with the data point, namely what area or “room” the object constructed from that part of a scan belongs to, after refinement in later stages of the algorithm.

In one embodiment of the invention there is provided a computer implemented method in which the method comprises the intermediate step of defining an arrangement graph. This is seen as a useful aspect of the present invention as it will clean up false positive probability prior to the generation of the model, thereby providing a more accurate model and reducing the computation overhead. In addition, by defining an arrangement graph, the method according to the invention is able to handle occlusions more effectively than other offerings.

In one embodiment of the invention there is provided a computer implemented method in which the method comprises the step of generating the parametric structural design model using the arrangement graph. By using the arrangement graph to generate the parametric structural design model, the method will provide a more accurate model, with less errors and will obviate many of the model inaccuracies that can creep in due to occlusions.

In one embodiment of the invention there is provided a computer implemented method in which the method comprises the additional intermediate step of : generating a plurality of IFC structural objects in addition to the walls, the floors and the ceilings, from the PC. This is seen as a useful way of capturing the different components in the building and also differentiating between different objects.

In one embodiment of the invention there is provided a computer implemented method in which the step of generating the parametric structural design model further comprises generating the parametric structural design model with the plurality of IFC structural objects, and the properties of those objects from the IFC specification. This is seen as a useful way of creating an information-rich and useful model.

In one embodiment of the invention there is provided a computer implemented method in which the parametric structural design model comprises an IFC model including an IFC schema file classifying all object types and object characteristics.

In one embodiment of the invention there is provided a computer implemented method in which the method comprises the intermediate step of, after receiving the PC, subsampling the PC data points according to a three-dimension (3D) voxel grid. In this way, all of the points from the different poses representative of a single location can be combined into a single point for ease of processing and reducing the computational burden.

In one embodiment of the invention there is provided a computer implemented method, further comprising the steps of: applying a normal estimation function across the subsampled PC data points; and, assigning a 3D normal vector to each data point in addition to their 3D Cartesian coordinate. The 3D normal vector will assist in the identification of the location of the data point and the plane to which it belongs. It will further assist in weeding out points forming parts of planes that are not required (for example, planes that are neither horizontal nor vertical).

In one embodiment of the invention there is provided a computer implemented method, further comprising the step of planar object recognition including: defining each planar object as the equation of its plane, a surface normal vector and the set of data points that lie on its plane. Again, this is a useful way in minimizing the data points and planes that must be processed.

In one embodiment of the invention there is provided a computer implemented method comprising the steps of: defining a projection function from 3D to two dimension (2D) so that a data point may be mapped from 3D onto a flat 2D surface; and defining a reprojection function from 2D to 3D so that the point may be mapped from a 2D plane into 3D space. This is seen as a particularly useful aspect of the invention as the data points and planes may all be reduced into a 2D representation which will facilitate processing. By storing points in a 2D grid, a simpler solution is provided.

In one embodiment of the invention there is provided a computer implemented method comprising the step of projecting the points associated with a plane to 2D and re-projecting those points back into 3D in order to form the vertices of a simple rectangular collision mesh. The advantage of this step is that there are no longer infinitely long planes, but rather now there is only the part of the plane that “can” be associated with the point cloud. Also, these new “bounded planes” have an exact surface area that is easier to manage as a known area versus infinitely long planes.

In one embodiment of the invention there is provided a computer implemented method in which the method comprises the step of collapsing all the data points into a 2D array and applying a Gaussian smoothing technique to the 2D array. In this way, it will be possible to more clearly define the different areas of the built structure which will facilitate creation of a more accurate floor plan and model of the structure.

In one embodiment of the invention there is provided a computer implemented method in which the step of determining the planes not to be included in the parametric structural design model comprises determining those planes that are neither horizontal nor vertical.

In one embodiment of the invention there is provided a computer implemented method in which the step of determining the planes that are to be included in the parametric structural design model comprises determining those planes that are either vertical or horizontal. By determining those planes that are either vertical or horizontal, it is possible to determine the walls, the ceilings and the floors of the building. These components are the building blocks of the model and once correct, it is easier to add to that model with confidence. For example, it will be easier to add other model features such as, but not limited to, windows, doors and the like.

In one embodiment of the invention there is provided a computer implemented method in which for those planes that are vertical, determining whether the vertical plane relates to one of an internal wall or an external wall. This will assist in determining the properties of that wall and useful for providing information of the object in the model.

In one embodiment of the invention there is provided a computer implemented method in which the step of determining whether the vertical plane relates to an internal wall or an external wall comprises determining whether there is another vertical plane spaced apart from but within a threshold distance from the first vertical plane. This is seen as a relatively simple and efficient way of differentiating between an internal and an external wall in a built structure that will allow the attributes of the wall to be set with relative ease.

In one embodiment of the invention there is provided a computer implemented method in which for those planes that are horizontal, determining whether the horizontal plane relates to one of a ceiling, a floor or a slab intermediate floors. This will also assist in determining the properties of that object and will be useful for providing information of the object in the model.

In one embodiment of the invention there is provided a computer implemented method in which the step of determining whether the horizontal plane relates to a ceiling, a floor or a slab intermediate floors comprises determining whether there is another horizontal plane spaced apart from but within a threshold distance from the first horizontal plane. This is seen as a relatively simple and efficient way of differentiating between floors, ceilings and slabs in a built structure that will allow the attributes of the object to be set with relative ease. the ceilings may be differentiated from the floors by determining the vertical spacing (i.e. the z value of the cartesian coordinates of the object).

In one embodiment of the invention there is provided a computer implemented method in which the method comprises the additional step of performing structure opening detection. This will allow for the identification of the windows and/or doors in the structure for accurate modelling.

In one embodiment of the invention there is provided a computer implemented method in which for a structure opening that extends to the floor, designating the structure opening as a door, and for a structure opening that does not extend to the floor, designating the structure opening as a window.

In one embodiment of the invention there is provided a computer implemented method in which the method comprises the additional step of performing spatial volume detection. This will allow for the identification of certain apparatus or structural items inside the structure that may be located within the structure for accurate modelling.

In one embodiment of the invention there is provided a computer implemented method as claimed in any preceding claim in which the method comprises the step of performing column detection. In addition to walls, ceilings, floors, spatial volumes, doors and windows, simple structures such as columns, which may be vertical columns or horizontal columns (beams) may provide for a useful reference point in the model and a more accurate model.

In one embodiment of the invention there is provided a computer implemented method in which the method comprises the initial step of defining structural model objects and parametric attributes for each of the objects.

In one embodiment of the invention there is provided a computer implemented method in which the IFC model is a model view definition (MVD).

In one embodiment of the invention there is provided a computer implemented method in which the IFC model is in a STEP Physical File Format (SPFF).

In one embodiment of the invention there is provided a computer program product having program instructions that when loaded on a computer, cause the computer to perform the method of any one of the claims.

### BRIEF DESCRIPTION OF THE DRAWINGS:

The invention will now be more clearly understood from the following description of some embodiments thereof given by way of example only with reference to the accompanying drawings, in which:

FIG. 1 is a diagrammatic representation of a 3D scanner generating a point cloud of a built structure;

FIG. 2 is a diagrammatic representation of the structure to be modelled;

FIG. 3 is a view of the planes constructed from the data points of the PC;

FIG. 4 is a diagrammatic representation of the model with some of the planes removed;

FIG. 5 is a diagrammatic representation of a scanning operation;

FIG. 6 is a diagrammatic representation view of the model after further processing;

FIG. 7 is a diagrammatic representation of the model after Gaussian smoothing;

FIG. 8 is a diagrammatic representation of the model with many of the data points and planes removed;

FIG. 9 is a diagrammatic representation of the planes represented in a 2D mesh;

FIG. 10 is a diagrammatic representation of the planes represented in a 2D mesh similar to FIG. 9 but with the vector retrieved from the horizontal label dataset grid's cells, collected and combined to be stored as part of the face data thereto, indicative of their object type; and

FIG. 11 is a diagrammatic representation of the constructed model.

### DETAILED DESCRIPTION OF THE DRAWINGS

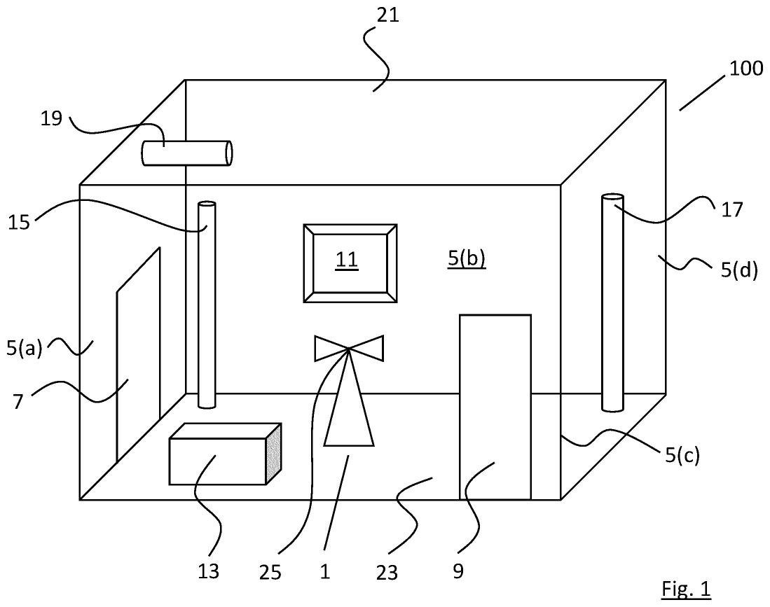

Referring to FIG. 1, there is shown a diagrammatic representation of a 3D scanner, indicated generally by the reference numeral 1, generating an unorganized point cloud of a built structure, indicated generally by the reference numeral 100. For the purposes of simplicity, the built structure 100 of FIG. 1 is illustrated as a single room however as will be understood from the remaining description and drawings, typically the invention will be applied to a building or other structure with multiple rooms or areas that require scanning. The built structure 100 is a room in which various objects are located including walls 5(a)-5(d), a pair of doorways 7, 9, a window opening 11, a generator 13, mechanical (e.g. water) ducting pipes 15, 17 and electrical cabling ducting 19. There is further provided a ceiling 21 and a floor 23. It will be understood that other objects could be provided however for the purposes of this illustration, only those shown are contained in the built structure.

As will be understood in the art, the 3D scanner 1 emits a plurality of laser traces radially outwardly from the point of origin 25 (i.e. the pose) along defined trajectories from the point of origin. Each of the laser traces will impact on one of the objects in the room 100 and a data point is created at the point of impact of the laser trace. Over time, as more and more laser traces are emitted into the room, an unorganized cluster of data points will be generated, forming an unorganized point cloud. This unorganized point cloud is effectively therefore a representation of the interior of the room as viewed from the point of origin. A number of points of origins may be selected and a number of unorganized point clouds can be generated. The data points will each comprise a set of coordinates including X,Y, and Z coordinates relative to the point of origin.

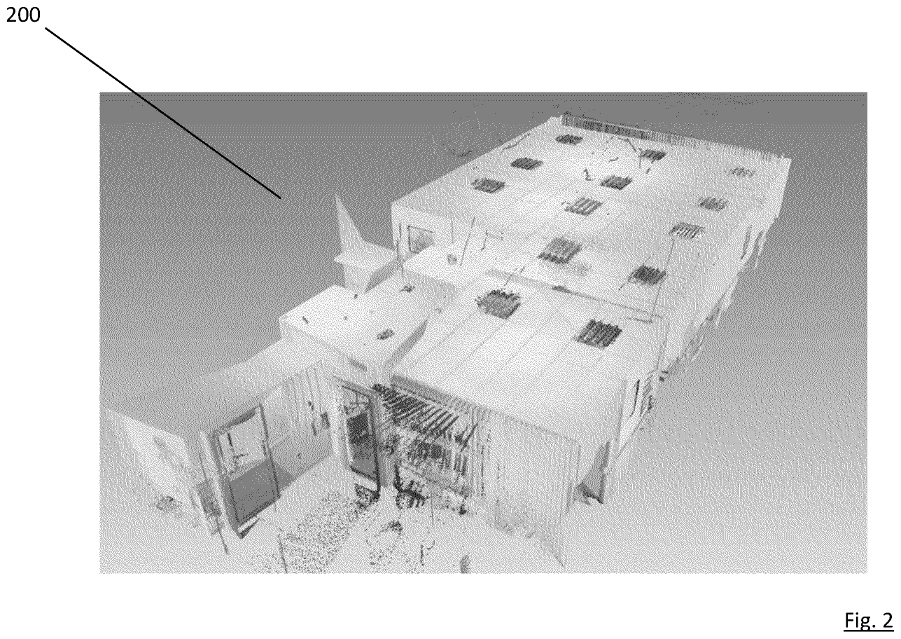

Referring now to FIG. 2, there is shown a point cloud (PC) representation of a more complex built structure, indicated generally by the reference numeral 200. The PC representation comprises an E57 file containing at least one, but preferably a plurality of scans of the built structure. By this, what is meant is that there will be a plurality of scans of each room in the built structure and not simply a single scan for each room in the built structure.

According to the computer implemented method, the method comprises loading an E57 file containing n scans, where n>=1. For each scan, the index of the scan is stored as a label for each point in the scan. For each scan, the data points are subsampled according to a 3D voxel-grid (this is optional). The scan points are then stored in a merged dataset. In other words, all of the scans are saved into the same array one after the other. Each data point contains the index of its original scan as outlined above, defining an explicit segmentation. This is stored as a vector of size n+1, where n is the number of input scans. The index of the current scan this point comes from is set to 1.0, and the rest are set to 0. The maximum label index, n+1, is treated as the outside/invalid label, when referring to points it means those that do not lie on a surface or lie outside of the room complex, and when referring to cells in grids (as will be explained later) it means an empty cell without any points or labels present.

The method according to the invention subsamples the points to reduce the size of the E57 file by reducing the density of the point cloud, e.g. from a PC with 1 million points, to one with the coverage representation only having, for example, of the order of 300,000 points, and the size could reduce from of the order of 60 GB to 5.7 GB. The size to density ratio given here is simply provided as an example. The method then stores the subsampled data in a merged single dataset so it is easier to utilize in other steps versus many non-merged data points. The advantage of this is that it affords the second pass mentioned later. In that pass, the points now have a relationship with the “room” they are in, where the goal later in this step is to filter out points that are not needed based on their scan pose relationship and the weighted relationship they have with the room they are in.

In addition, one could not efficiently retrieve and reuse the needed data if it were not stored in the manner described. It would be far more difficult and suggests that many more steps would be needed, i.e. retrieving non-merged data from separate locations. The proposed method does help in the assigning of points to the correct planes and rooms, here and in subsequent steps. Furthermore, the merging of points in this manner appears to be a more elegant solution than an alternative solution that would not encompass this approach, for example, storing the points as a histogram and thereafter applying a Hough Transform. Once the merged data set has been created, a normal estimation function is applied across the data points of the merged scan dataset. Each data point will be assigned a 3D normal vector, in addition to their 3D xyz Cartesian coordinate.

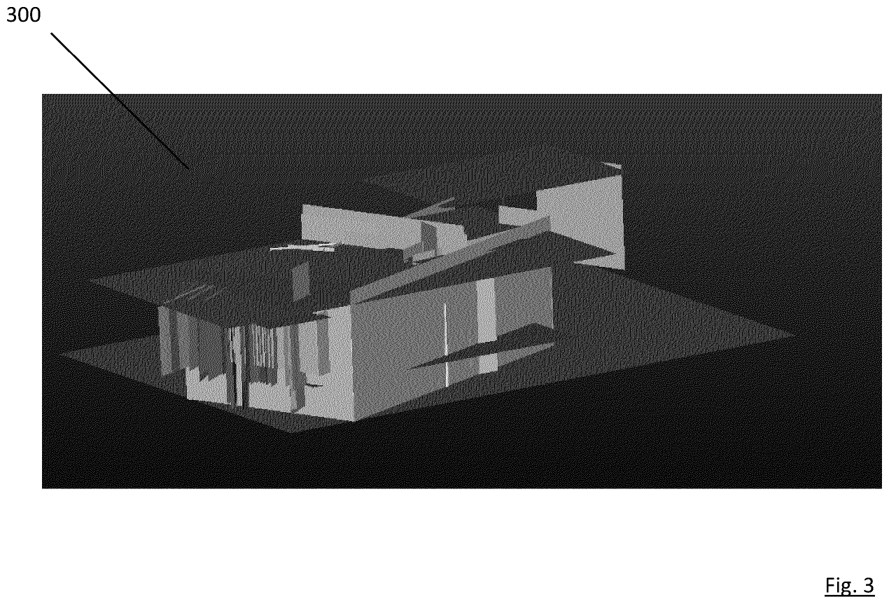

Referring now to FIG. 3, once the merged data set has been created, a normal estimation function has been applied across the data points of the merged scan dataset and each data point has been assigned a 3D normal vector, the computer implemented method comprises the subsequent steps of: applying a random sample consensus (RANSAC) planar shape detection function to the merged scan dataset. Each planar shape is defined as the equation of its plane, a surface normal vector, and the set of points that lie on it. A projection/reprojection function from 3D to 2D and from 2D to 3D is defined, so that data points can be mapped onto the flat 2D surface of the plane and also from the plane back into 3D space along its surface. The points associated to a plane are projected to 2D and a bounding-box is computed, whose corner points are re-projected back into 3D in order to form the vertices of a simple rectangular collision mesh. The resulting dataset consists of “bounded planes”, as illustrated graphically in the structure 300 of FIG. 3. Instead of using RANSAC for planar shape detection, other methods of planar detection could be used instead, including, but not limited to, a Hough Transform. The above step is preformed because the RANSAC Least Squares plus Voting approach and method is preferred over other investigated approaches for finding parametric shapes, for example, the Hough Transform. The above paragraph refers simply to RANSAC planar detection.

For each bounded plane, the computer implemented method carries out the steps of: determining whether the bounded plane is classified as horizontal, or vertical, within approximately 1 degree of the horizontal or vertical. It does this by checking the direction of its surface normal vector. Once it has determined if the bounded plane is horizontal or vertical, the method defines in its 2D projection space, a grid of fixed dimensions. This is referred to as the labelling grid. Each cell in the labelling grid contains a vector of size n+1, where n is the number of scans from the input E57 PC file. This will contain percentage weights for each scan index, now treated as a label. Each cell in the labelling grid is initialized with the zero vector (every element is 0); and a supporting data structure of similar design, called the occupancy grid, is created at a larger dimension size than the labelling grid. This is filled with true/false Boolean values if any of the cells contain points, is used to speed up checking surface areas for points, and initializes to false.

The labelling data part is important because it is used to define point-room associations by assigning the cells/regions of the labelling grid that points lie on to particular room labels, then through a process of iteration (detailed over the next few paragraphs), refining the labelling to produce a clearer point-room association.

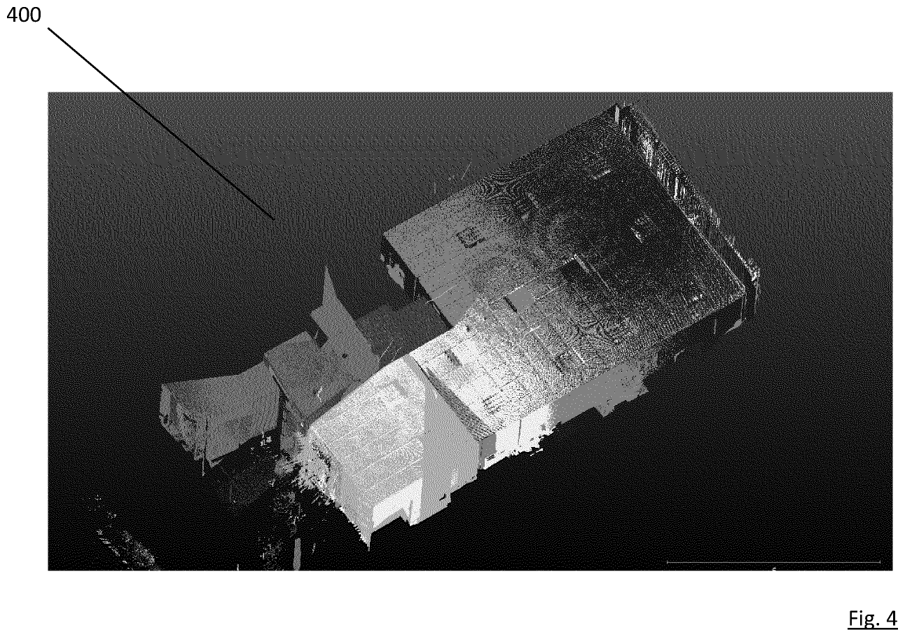

Referring now to FIG. 4, there is shown a structure 400 that has undergone 1st Pass Labelling (“grid labelling”). Grid labelling comprises the steps of: (i) for each data point associated to a surface, project the data point to 2D, onto the surface, and map to grid cell coordinate in both the labelling and occupancy grids; (ii) when mapped to the labelling grid, add this data points label as a weight to the cell's label vector (e.g. if scan 3 is where the point came from, that index into the vector gets 1.0 added to it); (iii) when mapped to the occupancy grid, assign the cell to true, i.e. there are point(s) present; and (iv) after iterating across all points belonging to a surface, normalize each cell's label vector by dividing it by the sum of all its elements.

The method provides for weighted labels in each cell on the grid, and this part of the algorithm produces those needed weighted labels for each cell in the surface/plane labelling grids. Later, this data is used to refine data point to room associations, and the method produces computational iterations by means of a Gaussian Kernel, as will be discussed in more detail below.

Furthermore, the occupancy grid speeds up querying room/space areas to see if points are present (memory optimization as it is fewer cells but larger cell dimensions). Is not strictly necessary for the algorithm, but is a chosen performance improvement for the method. Alternatively, the labelling grid alone can be used for checking things in all cases versus the methods weighted labelling giving a single value, but that is more costly as it doesn't cache simple true/false values if points are present. This True/False choice for the algorithm is optimal.

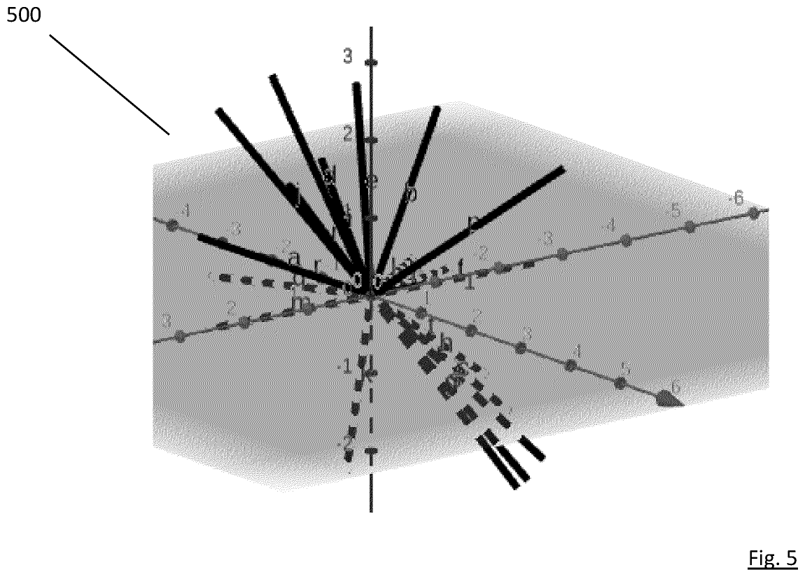

Once 1st pass labelling is complete, the method continues to 2nd Pass Labelling (“point re-labelling”) which comprises the steps of: (i) constructing a 3D ray-casting environment (as illustrated diagrammatically by the ray casting environment 500 of FIG. 5) using the collision meshes defined for each planar surface; (ii) building acceleration/support data structures (bounding-volume hierarchies); and, for each point in the merged dataset: (iii) get the points normal vector; (iv) from the points 3D xyz coordinate, randomly sample of the order of 20 direction vectors in the hemisphere of the positive point normal. This is achieved via a uniform random distribution of 3D vector elements and flipping/reversing any that do not point in the positive normal direction within 180 degrees; (v) use the point xyz coordinate as a ray origin, and define a ray trajectory along each of the sampled direction vectors; (vi) the result is a set of rays to cast from each point. The above steps are performed as_it is necessary to find nearby points that we want to be labeled the same as the majority in a given room, i.e. ray-casting from a single point to find other points to label similarly. The rays are casted from individual points to hit the cell grid on the surfaces/planes, as described in more detail below.

Thereafter, the method comprises the steps of: (vii) casting all defined rays into the 3D environment; (viii) for each intersection with bounded planar surfaces, project intersection points to 2D on the plane's surface and test if any lie within the cell grid, using the occupancy grid for coarse checks and the label grid for fine checks if occupancy is true; (ix) for any ray intersections that have valid label grid cells mapped to them, retrieve the label vector from the cell and add it to the point's label vector; (x) after all raycasting has been conducted across all points, normalize each points label vector by dividing it by the sum of its elements.

Basically, one can think of points that are already associated with the surface 2D planar grids, and we obtain reliable points according to those values/labels given to those point when they were originally associated with the surface 2D planar grids.

As previously discussed, some labels are outside labels, and others are interior labels but not all of them are corresponding with the correct room/space association. Here, we are trying to improve the points to correct room association. The “relabeling” being conducted is done via what are referred to as visibility checks using ray-casting, i.e. the rays are intersecting with cells on the grid identifying the existing labels within the grid(s). This is the first step in identifying whether or not to change/fix the label to the correct room association. The logic being, that parts of the same room can be seen from one another, therefore rays cast from points on surfaces should theoretically intersect with other surfaces in the same ‘room’. Relabeling as a result of this changes the label weights for surfaces and their points to try and better approximate room layout.

As for the outside labels, they act differently in relation to ray casting. It is assumed that casting rays about an Outside Labeled point will not yield any room layout hits, i.e. does not hit any interior surfaces because the point is “outside”. In this case a high value is given to these points to assure they are labeled as “outside”.

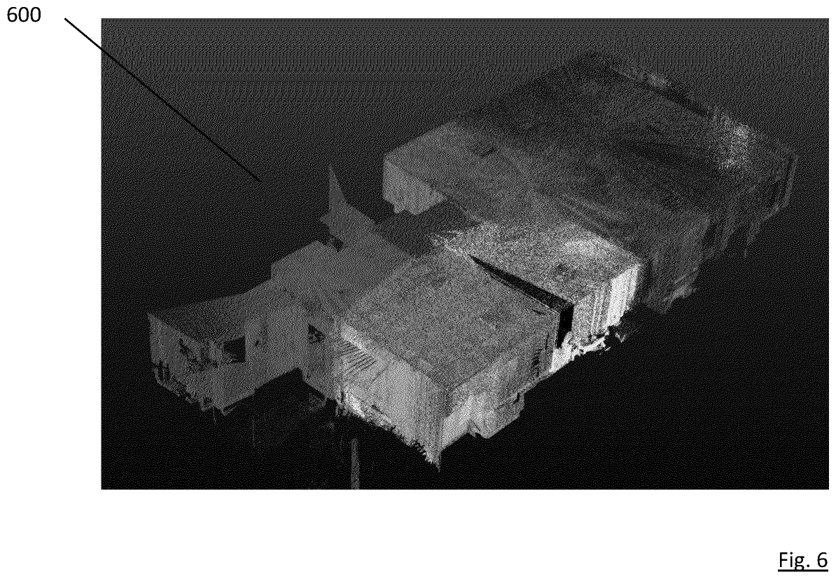

The 1st and 2nd pass labelling are repeated sequentially for of the order of three iterations. This will repeatedly update the label grids and point labels, resulting in the model representation 600 illustrated in FIG. 6.

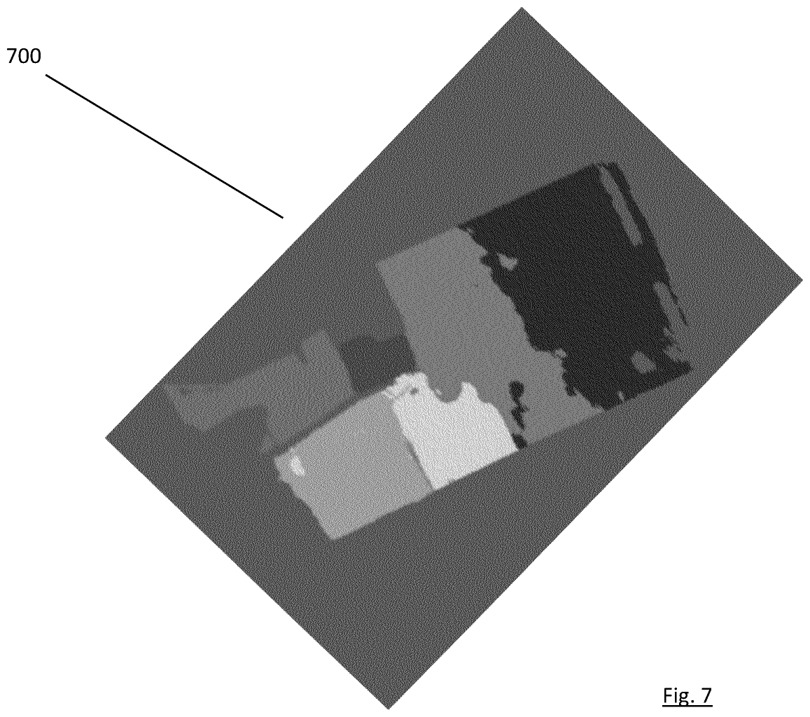

For each surface label grid, a Gaussian smoothing is applied across the stored label vectors. Other smoothing techniques could be used. The result of this smoothing, i.e. the bounded planes and their labelling grids, are referred to as the “vertical label dataset” and is illustrated diagrammatically in the model representation 700 of FIG. 7. Effectively, the planes have all been “flattened” or reduced to a 2D representation which assists in more clearly defining the room boundaries of the model, with further processing to do. This step will clear up previous labels, by adding them together and taking an average.

Smoothing helps remove “noise” caused by mis-labeled points that were associated to the wrong room, and said “noise” is removed within the final labelling grids so that cleaner room associations can be determined, and in the case of the image, visualized. From then on, vertical surfaces are flattened into a floor-plan-like graph to compute enclosed room areas in later steps.″

The computer implemented method thereafter comprises the steps of: (i) acquiring the global horizontal plane (0, 0, 1), i.e. a Z-up vector, and (ii) creating an infinite plane representing this, with the same functionality as the bounded planes created during RANSAC. Similarly, a labelling grid is constructed in the 2D space of this plane bounded by the extent of the merged point cloud/scan dataset. In this way, edges of the model are created, bounds on the infinite planes effectively boxing them in.

This flattening of the point cloud to a single horizontal plane is used to create a floor-room association via the point labels. This should correspond with enclosed areas derived from a 2D graph (later in the process), i.e. when one overlays the re-aligned arrangement graph in the visualization, and places it on top of this step of the flattened points. Both together are needed for point and edge association which is required both as graph optimization inputs and to cut said graph arrangement.

For each data point in the point cloud, the computer implemented method performs the steps of: (i) projecting the data point from 3D to 2D as defined by the global horizontal plane; (ii) mapping each 2D point to labelling grid cells; and (iii) accumulating point label vectors similar to the 1st pass labelling, and storing them in the cells of the global horizontal plane's labelling grid. Once all points have been iterated, the labelling grid is normalized (like before), and a Gaussian smoothing operation is applied to it. The result of this smoothing, i.e. a bounded plane covering the ground extent of the point cloud complete with a labelling grid filled by every point, is referred to as the “horizontal label dataset”. This process is the same noise removal as mentioned above, but now for the Horizontal Data set. Again, this produces a cleaner result dataset for the room labelling.

Once the horizontal label dataset is constructed, the next step entails finding suitable wall candidates. This is achieved by first of all creating lines by, for each bounded plane in the vertical label dataset: (i) project its corner points into the 2D space of the horizontal label dataset; (ii) define a line equation that crosses its corner points and encode a reference in this line to the vertical bounded plane it was created from; (iii) store this as a single-sided wall candidate line. This technique is to create a floor-plan-like graph “constellation” that is used to defined room boundaries and areas covered by rooms.

For each bounded plane in the vertical label dataset (again): (i) project its corner points into the 2D space of the horizontal label dataset; (ii) as a line, search the 2D space for any other line whose normal vector is parallel or with of the order of 1 degree of parallel and pair them; (iii) for each prospective “pair”, the current line is treated as the “front”, and its counterpart returned from the search is the “back”; (iv) from the front line, get its bounded planar surface; (v) from the back line, get its bounded planar surface; (vi) for each cell in the occupancy grid in the front surface, overlay via 2D, project onto the back surface, and compute the common overlap across both occupancy grids in terms of surface area. If the surface area is above approximately 1 (metres squared), then store the pair of lines as a double-sided wall candidate line. Otherwise discard. Double-sided wall candidate lines maintain a reference to both bounded planes that created them. Also, a common normal is derived from the two normal vectors of the lines that are paired. This allows for both single- and double-sided wall candidates from 2D graph lines, representing exterior with single-sided and interior as double-sided. Opposing normals are also required for the double-sided, i.e. room labels do not match meaning different room associations for points to planes labels, and the result estimates the wall thickness, versus being predefined as the single-sided are for exterior walls.

For each single and double-sided wall candidate line, an offset to a theoretical centerline is defined by either applying a fixed size offset in the reverse direction of the normal to single-sided lines, or by computing the centerline between the paired lines in the double-sided case. This centerline represents the “wall” candidate, i.e. the position and direction of the potential wall that can be extruded from the horizontal plane. An array is created representing a one-dimensional (1 D) variant of the standard 2D labelling grid, whose extent is determined by the length of the line segment divided by the labelling grid cell size. For each labelling grid in the reference bounded planes, the method flattens the 2D column in the vertical surface grid that lies above the corresponding horizontal line array, by accumulating the label vectors into a single result.

Any given centerline represents the theoretical “line” of that wall candidate without width/thickness, only orientation and extent. Thickness for interior wall structure candidates is estimated from the stored label data, the single-side are predefined as mentioned before, and height and length are determined in a different step.

For double-sided wall candidate lines, the occupancy grid is checked in the second vertical surface grid and the method only accumulates label vectors from cells in the first surface that lie on occupied areas of the second surface. For double-sided wall candidate lines, a front->back and back->front label array is created for both sides of the wall candidate, allowing each side to in turn act as the primary label grid being accumulated whilst the other acts as the occupancy check. Thereafter, the computer implemented method normalizes all label vectors, i.e. “V” is a label vector, in the 1D array by dividing them by the sum of their elements, modified in the following way where S is the temporary sum of non-outside elements: the “outside” label (index n+1) is cleared and replaced with:

$$S = {\sum }_{i = 0}^{n} {V}_{i}$$

$${V}_{n + 1} = ( \frac{H}{P r} ) * ( \frac{L r}{P r} ) - S$$

if and only if this result is greater than 0, where H is a constant expected wall height value (0.5 metres), Pr is the cell size/resolution of the bounded plane's labelling grid, and Lr is the cell size/resolution of the 1D array of vectors acting as the line's labelling grid. After this outside label re-computation, a standard normalization takes place. If the result of the outside label re-computation is negative, the outside label is set to zero before standard normalization takes place. Thereafter, the 1D array is smoothed using a Gaussian kernel. This is required for normalization of all n label vectors, smoothing, and for horizontal plane identification. With these checks, the data can be used in subsequent steps.

Thereafter, the method proceeds to identify the horizontal planes that may form ceilings, floors or slabs intermediate floors of the built structure. The computer implemented method creates wall elevations by, for each bounded plane, produced by RANSAC, marked as horizontal (not the global horizontal plane): (i) performing the same overlap pair detection applied to vertical surfaces, this time oriented horizontally; (ii) storing single-sided horizontal “slab” surfaces as either a floor or ceiling based on the height of the points associated with the planar surface and the direction of the surface normal vector; (iii) storing double-sided horizontal “slab” surfaces produced by the parallel pair overlap checks as “separating” slabs. Overlap detection using occupancy grids is the same as the vertical surface overlap detection and pairing, the only major difference being that the bound plane determined as the “top” must be positioned above (at a higher Z-level) than the bound plane determined as the “bottom”.

These horizontal bound planes are stored as “elevation” candidates, i.e. potential floors and ceilings. For each single and double-sided elevation candidate, the computer implemented method comprises the steps of: creating a 2D labelling grid for the elevation candidates, transfer label vectors from their respective sets of associated points and normalize the resulting cell grid. For double-sided candidates, the computer implemented method comprises the steps of: storing a separate top and bottom labelling grid derived from the paired bounded planar surfaces used to create/define this elevation; and sorting the set of elevations in ascending order according to Z-height. At this point, we are particularly interested in the planes that have room labels on one side (the inside), and non-room label (outside). Different sides of a floor or ceiling should have one side labelled as part of a room inside, and the other non-room associated labels as “outside”. This is required to determine whether slabs, i.e. horizontal planes, are to be identified as a valid floor, or a valid ceiling.

The computer implemented method then defines an arrangement graph. This is achieved by (i) defining a 2D space bounded by the extent of the merge point cloud/scan dataset; (ii) within this 2D space, transfer the “wall candidate” lines into said space; (iii) extending each line's finite segment up to the bounds in 2D defined by the extent of the merge point cloud/scan dataset; (iv) dividing each line based on the intersections with other lines. This produces a set of edge segments, who shall derive their labelling information from the wall candidate lines that created them. Edge segments created from a double-sided wall candidate surface, between the edge segments, this intersection operation will produce a set of enclosed polygonal faces. Each face keeps a reference to the edge segments that surround it, and vice-versa (each edge references the faces it lies adjacent to). An arrangement graph is constructed from these two new elements. Faces become the nodes of the graph, and edge segments define the graph edges between faces. This is all provided to allow for cutting out the final “Floor Plan” by means of energy minimization. The result is a reduced set of lines/edges that have room labels, and can be used to attempt to reconstruct an enclosed room environment by extruding upwards in 3D from the 2D graph.

As a next step, label data is transferred. For each edge, the method (i) retrieves the wall candidate line it was created from; (ii) retrieves the length and endpoints of the edge segment; (iii) along the length of the edge segment, randomly sample a set of positions. These positions correspond to indices along the 1D labelling array of the entire line, allowing a portion of its label data to be selected within the length of the edge segment; (iv) accumulate the set of label vectors from the 1D labelling array according to the positions/indices sampled. Combine into a single label vector to be stored as part of the edge segment; (v) perform a standard normalization of the resulting label vectors for each edge segment by dividing each element by the sum of all elements in that vector; (vi) perform an adjusted “room-relative” normalization on the resulting label vectors for each edge segment, such that the combined sum of:

$${\sum }_{i = 0}^{n} {V}_{i} + {\sum }_{i = 0}^{n + 1} {V}_{i} = 1$$

This is performed by finding the max the label vector, i.e. M=max(V), between 0 . . . n (not including the outside label, i.e. index n+1), and applying to each element of the vector the operation where Vₙ₊₁ is the outside element:

$${V}_{i} = {V}_{i} * \frac{( 1 - {V}_{n + 1} )}{M}$$

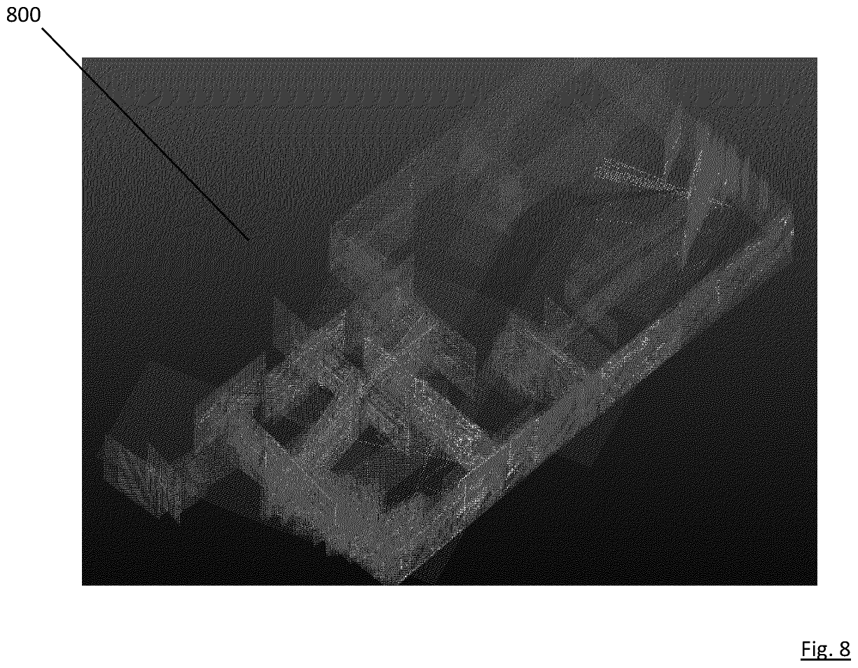

for each index i, where i <n and i!=n+1 (i.e. not the outside label). For each face, the computer implemented method comprises the steps of: (i) retrieving the global horizontal plane's labelling grid, i.e. the “horizontal label dataset” constructed earlier; (ii) sampling random points across the surface area of each face polygon, and access the horizontal label dataset using these sampled points; (iii) for each label vector retrieved from the horizontal label dataset grid's cells, accumulate/combine them into a single label vector to be stored as part of the face data; and (iv) apply the standard and room-relative normalization procedures outlined above for the edge label vectors. This will result in the model representation 800 illustrated in FIG. 8. This part of the algorithm is to reduce the impact of outside invalid, i.e. −1 label values, when aggregating label weights so that valid room associations are more prevalent for the energy optimization. It helps ensure we have correctly associated room labels assigned to edges to assist in the determination of the final cut graph, i.e. the floor plan is utilized to reconstruct the model.

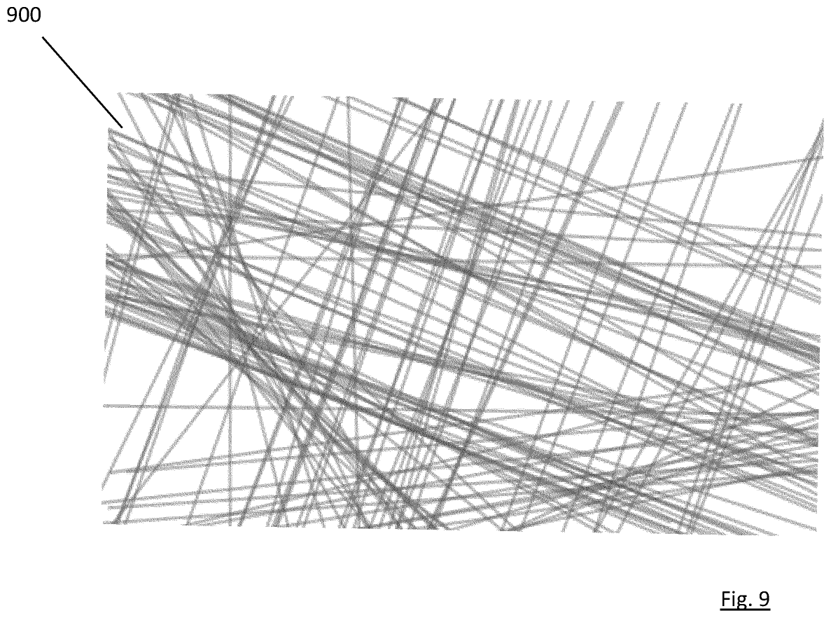

Referring to FIG. 9, there is shown an illustration 900 of the results of a graph optimization technique. A graph-cut is applied according to the GCO library (a multi label optimization library developed by Olga Veksler and Andrew Delong). Instead of this specific technique, alternative graph label optimization techniques could be applied to good effect, for example, the Gurobi Optimizer technique, Center for Biomedical Image Analysis (CBIA) Graph Cut Library, or other techniques could be used in its stead. The graph optimization filters out edges/lines that are not needed in the final model.

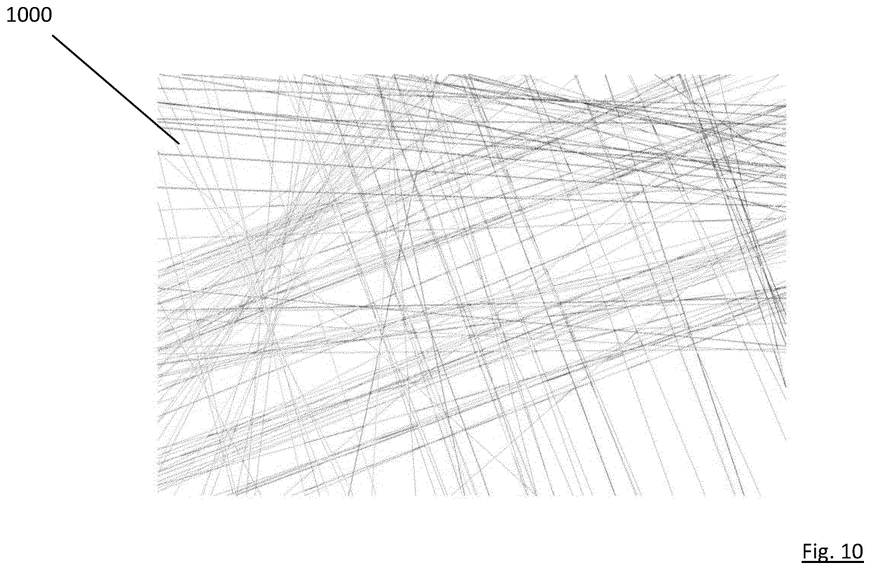

According to the graph optimization, in order to establish a final room layout, all faces in the arrangement graph that are labelled the same and can be found via a connected-components search are treated as one room. Faces whose labels are discontinuous, i.e. differ from one another define the expected boundary between rooms. In order to establish which edges belong to valid wall candidates, they must separate faces of differing labels. An energy minimization approach is used to determine the final set of valid edge segments/wall candidates via graph-cut optimization, as illustrated by the model representation 1000 in FIG. 10.

Thereafter, the computer implemented method reconstructs the room layout from the cut graph. This is achieved by creating a copy of the arrangement graph data as a reconstruction dataset, and, for each edge segment, retrieve faces from either side of the edge, and test if labels are non-equal; for all equal labels, remove from the input dataset, leaving only those edges that have discontinuities between the faces they separate. If the labels are equal, then they are invalid and should be removed because no wall edge in this process should be associated to the same room structure (points in the PC) on both sides. Instead, only edges with room labels associated with a single side are kept. Also, short walls that only protrude into a room area, but do not help enclose a given area, are not required in the final graph representation utilized for the model reconstruction.

Next, the method comprises the step of retrieving the elevation dataset, and for each elevation: for those that are marked as “floor” or “separating” surfaces as outlined above, check proportions of label weights in each cell of the “top” labelling grid. If the outside/empty label (index n+1) is less than 50% of overall label weights in the vector, then map onto the graph face dataset the center point of the grid cell. If a face is retrieved successfully, i.e. the picking is not out-of-bounds of the 2D surface all faces are encoded on, then increment a hit counter for that elevation. For those that are marked as “ceiling” or “separating” surfaces as outlined above, apply the same check but with the “bottom” labelling grid instead. This overlap mapping checks for floor/ceiling pairs that have the correct facing, and matching room labels. Floor and ceiling marked-surfaces are supposed to have one side facing each other with appropriately corresponding labels. Separating surfaces potentially divide the room space into more than one room via height, and must also be considered during the pairing of elevation surfaces.

Other methods do not result in “connected” walls ceilings, slabs etc. The invention is achieving a building information model from a PC, where the resulting model is connected on the semantic level, i.e. the horizontal surfaces/slabs resulting from this method are both classified as roofs or floor slabs, and those resulting objects have embedded connected entity relationships based on a data model, which are the result of an unsupervised method. Other methods rely on manually making this connected relationship. Also, it is envisaged that to not do it in this way could result in simply slabs, not distinguishable floors vs ceilings, which could be said to be not as efficient.

The method then performs opening detection across the entire 3D environment. This entails detecting those opes in the wall structures that extend all the way to the floor and those opes in the wall structure that do not extend all the way to the floor. Those opes that do extend all the way to the floor are designated as doorways and those opes that don't extend all the way to the floor are designated as windows.

The method then performs cylindrical column detection in the 3D environment using RANSAC configured with cylindrical shape detection. Each cylindrical shape is tested against a given minimum/maximum radius, and minimum height, to establish if it is large enough to be treated as a column. Each cylindrical shape is then tested based on the direction of the cylinder, i.e. the vector it is oriented upon, versus the global vertical Z-up vector, within approximately several degrees of “up”, i.e. parallel within 1 to 2 degree of the Z-up vector. All that do not meet this test are rejected. Finally, every valid cylinder's direction, radius, and height is stored as a vertical column object. Other structural object types will be envisaged.

Once this has been completed, the computer implemented method defines IFC entities whose properties correspond to the geometry that has been reconstructed. For each geometric object produced by the reconstruction, the computer implemented method maps the type according to the following list:
i. Remaining vertical edge segment/wall candidate surfaces (IfcWallStandardCase).
ii. Remaining horizontal elevation floor/ceiling candidate surfaces (IfcSlab).
iii.Remaining cylindrical vertical column objects (IfcColumn).
iv. Detected openings inlaid into wall candidates that do not extend to the floor (IfcWindow).
v. Detected openings inlaid into wall candidates that do extend to the floor (IfcDoor).
vi. 3D polygonal cells formed by the enclosure of intersecting wall and slab geometry (IfcSpace).

For each object mapped to corresponding entity type in the Industry Foundation Classes (IFC) data model schema, the computer implemented method applies shape definition based on geometric properties, such as, but not solely limited to one or more of: height, width, thickness (of walls) and the like. For example, for each object mapped to corresponding entity type in the ISO 16739 IFC data model schema/ontology, apply shape definition based on those geometric properties. The current implementation applies the IfcOpenShell class hierarchy to automatically define the entity hierarchy for the IFC output. Thereafter, all reconstructed IFC entities are exported to a SPFF file and each object mapped to a corresponding IFC entity type, and whose properties have been defined according to the reconstructed geometry.

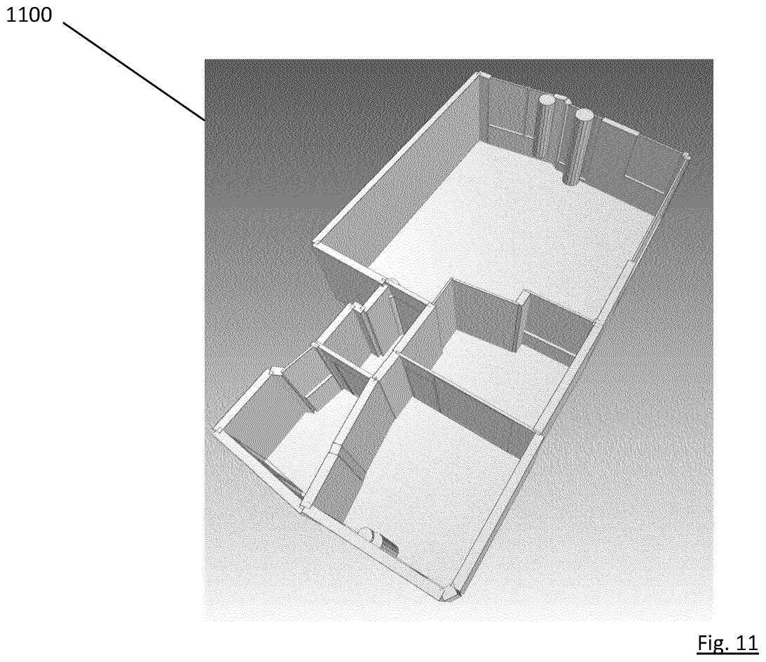

This gives the objects the semantic data of the IFC model and provides structure to those objects and aids in the identification of those objects. The resulting simulation model 1100 as illustrated in FIG. 11.

Various modifications may be made to the foregoing embodiments without departing from the scope of the appended claims or bounds of the invention. While the computer implemented method and the computer program product are both solely focused on ordered point clouds with scan positions, the invention, for automatically generating a semantic rich structural parametric design structures from a built structure, is not limited solely to ordered point clouds.

In broad terms, the present invention relates to a computer implemented method for generating a parametric structural design structure from a built structure comprising the steps of: receiving an unorganized point cloud (PC) of the built structure, the unorganized PC containing a data set with a plurality of data points and one or more scan positions, i.e. poses, each of which has an RGB value associated therewith; identifying objects in the unorganized PC by determining the data points in the unorganized PC that need to be generated into model components that will represent the design structure; and generating an Industry Foundation Classes (IFC) model of the designed structure, the IFC model including an IFC schema file classifying all object types and object characteristics in the final IFC model design structure. In this way, it is possible to generate a 3D building information model of the built structure efficiently and with a high degree of accuracy.

The present invention is referred to as an unsupervised method, as opposed to a supervised method. Supervised methods indicate that there is human intervention, e.g. in relation to the classification of objects as IFC or other steps of the overall algorithm not being automatic. Unsupervised methods do not require human intervention in relation to the classification of objects or other steps required for the desired result, and are in fact fully automatic. Unsupervised methods are of course more advantageous because the supervised portion is very laborious and time consuming.

Throughout the specification, reference is made to how the invention creates IFC coordination models directly from the point cloud, and how the models are formatted using ISO 10303 Part 21, i.e. STEP Physical File Format (SPFF). More specifically, the computer program product creates IFC2X3TC1 Coordination Model View Definition (MVD) files using the IFC Schema Version 2X3TC1 and the Coordination View 2.0 MVD (CV 2.0 MVD). However, the invention is not limited to IFC model creation in SPFF, nor this particular schema and MVD versions. For example, IFC4 (e.g. IFC4.3 RC1, etc.), IFC5 (e.g. IFC5.0.1 or IFC5.1.0, etc.), and future ISO 16739 data models and schema versions are optional to IFC2X3TC1, and the invention even covers the case where the MVD concept may be eliminated or replaced with alternative sub-set schema definitions and alternative exchange mechanisms because the invention is not bound by the MVD concept. Any format can be used as long as it conforms to the ISO 16739 IFC data model standard specification as per stated in the standard itself. Some examples are ISO 10303 Parts 26 and 28, and outside of the ISO 10303 STEP family formats such as ifcXML, ifcJSON, Turtle, RDF and ifcOWL. Said alternative IFC formats are inclusive of web based exchange of IFC model data warranting the invention to be not limited to file based exchanges on personal computers, of which at this moment in time, due to vendor adoption of said standards, ISO 10303 Part 21 is the predominant format chosen for the exchange of IFC data. The invention is also not limited to the IFC2X3 CV 2.0 MVD, it is utilized in the computer program product at this time due to wide support of the IFC2X3 schema. In fact, the computer program product can read and write using any IFC Schema, e.g. the creation of an IFC4 Design Transfer View MVD model, which is envisaged to be the next most supported MVD by vendors for the editing of parametric models in IFC format and is suited most for the next version of the inventions computer program product.

Throughout the specification, reference is made to the E57 format. However, the present invention is not dependent on the E57 format. For example, other formats could be used such as the E57 ASTM Standard

It will be understood that the invention further extends to a computer program product having program instructions for the computer implemented method. Furthermore, the invention further extends to a dedicated computing device programmed for carrying out the computer implemented method. The computing device may be a mobile phone, a so-called smart phone, a tablet, a phablet, a laptop, a personal computer or other device capable of processing the data in the manner described.

It will be further understood that various parts of the present invention may be performed in hardware and other parts of the invention may be performed either in hardware and/or software. It will be understood that the method steps and various components of the present invention will be performed largely in software and therefore the present invention extends also to computer programs, on or in a carrier, comprising program instructions for causing a computer or a processor to carry out steps of the method or provide functional components for carrying out those steps. The computer program may be in source code format, object code format, or a format intermediate source code and object code. The computer program may be stored on or in a carrier, in other words a computer program product, including any computer readable medium, including but not limited to a floppy disc, a CD, a DVD, a memory stick, a tape, a RAM, a ROM, a PROM, an EPROM or a hardware circuit. In certain circumstances, a transmissible carrier such as a carrier signal when transmitted either wirelessly and/or through wire and/or cable could carry the computer program in which cases the wire and/or cable constitute the carrier.

It will be further understood that the present invention may be performed on two, three or more devices with certain parts of the invention being performed by one device and other parts of the invention being performed by another device. The devices may be connected together over a communications network. The present invention and claims are intended to also cover those instances where the system and/or method is operated across two or more devices or pieces of apparatus located in one or more locations.

In this specification the terms “comprise, comprises, comprised and comprising” and the terms “include, includes, included and including” are all deemed totally interchangeable and should be afforded the widest possible interpretation.

The invention is not limited to the embodiments hereinbefore described but may be varied in both construction and detail within the scope of the appended claims.

1) A computer implemented method of generating a parametric structural design model from a built structure comprising the steps of:
receiving a point cloud (PC) representation of the built structure;
generating a plurality of planes from the PC;
determining those planes that are representative of objects to be included in the parametric structural design model and storing those planes in memory;
determining those planes that are not representative of objects to be included in the parametric structural design model and discarding those planes;
retrieving the properties of those objects to be included in the parametric structural design model from an Industry Foundation Classes (IFC) specification containing object property specifications; and
generating the parametric structural design model with the planes representative of the objects to be included, and the properties of those objects from the IFC specification.

2) The computer implemented method as claimed in claim 1 in which the PC contains a data set with a plurality of data points, one or more scan positions, a 3D coordinate value (XYZ), and a scan index value associated therewith.

3) The computer implemented method as claimed in claim 1 in which the method comprises the intermediate step of defining an arrangement graph.

4) The computer implemented method as claimed in claim 3 in which the method comprises the step of generating the parametric structural design model using the arrangement graph.

5) The computer implemented method as claimed in claim 1 in which the method comprises the additional intermediate step of: generating a plurality of IFC structural objects in addition to the walls, the floors and the ceilings, from the PC.

6) The computer implemented method as claimed in claim 5 in which the step of generating the parametric structural design model further comprises generating the parametric structural design model with the plurality of IFC structural objects, and the properties of those objects from the IFC specification.

7) The computer implemented method as claimed in claim 1 in which the parametric structural design model comprises an IFC model including an IFC schema file classifying all object types and object characteristics.

8) The computer implemented method as claimed in claim 1 in which the method comprises the intermediate step of, after receiving the PC, subsampling the PC data points according to a three-dimension (3D) voxel grid.

9) The computer implemented method as claimed in claim 8, further comprising the steps of: applying a normal estimation function across the subsampled PC data points; and, assigning a 3D normal vector to each data point in addition to their 3D Cartesian coordinate.

10) The computer implemented method as claimed in claim 9, further comprising the step of planar object recognition including: defining each planar object as the equation of its plane, a surface normal vector and the set of data points that lie on its plane.

11) The computer implemented method as claimed in claim 10 comprising the steps of: defining a projection function from 3D to two dimension (2D) so that a data point may be mapped from 3D onto a flat 2D surface; and defining a reprojection function from 2D to 3D so that the point may be mapped from a 2D plane into 3D space.

12) The computer implemented method as claimed in claim 1 comprising the step of projecting the points associated with a plane to 2D and re-projecting those points back into 3D in order to form the vertices of a simple rectangular collision mesh.

13) The computer implemented method as claimed in claim 1 in which the method comprises the step of collapsing all the data points into a 2D array and applying a Gaussian smoothing technique to the 2D array.

14) The computer implemented method as claimed in claim 1 in which the step of determining the planes not to be included in the parametric structural design model comprises determining those planes that are neither horizontal nor vertical.

15) The computer implemented method as claimed in claim 1 in which the step of determining the planes that are to be included in the parametric structural design model comprises determining those planes that are either vertical or horizontal.

16) The computer implemented method as claimed in claim 15 in which for those planes that are vertical, determining whether the vertical plane relates to one of an internal wall or an external wall.

17) The computer implemented method as claimed in claim 16 in which the step of determining whether the vertical plane relates to an internal wall or an external wall comprises determining whether there is another vertical plane spaced apart from but within a threshold distance from the first vertical plane.

18) The computer implemented method as claimed in claim 1 in which for those planes that are horizontal, determining whether the horizontal plane relates to one of a ceiling, a floor or a slab intermediate floors.

19) The computer implemented method as claimed in claim 18 in which the step of determining whether the horizontal plane relates to a ceiling, a floor or a slab intermediate floors comprises determining whether there is another horizontal plane spaced apart from but within a threshold distance from the first horizontal plane.

20) The computer implemented method as claimed in claim 1 in which the method comprises the additional step of performing structure opening detection.

21) (canceled)

22) (canceled)

23) (canceled)

24) (canceled)

25) (canceled)

26) (canceled)
